(19) United States
(12) Patent Application Publication
(10) Pub. No.: US 2007/0064928 A1
(43) Pub. Date: Mar. 22, 2007

(54) Safety cap phone

(76) Inventor: Javier H. Mariscal, Chula Vista, CA (US)

Correspondence Address: JAVIER H. MARISCAL, 1731 HELROSE AVE UNIT #41, CHULA VISTA, CA, 91911-6573, US

(21) Appl. No.: 11/214,150

(22) Filed: Aug. 29, 2005

(51) Int. Cl. H04M 1/00

(52) U.S. Cl. 379/452

(57) ABSTRACT

Safety Cap Phone with Antibacterial, and Essence. A cap that assembles to the speaker and the auricular of any phone and helps prevent the spread of disease and infections and also helps to avoid foul odors.

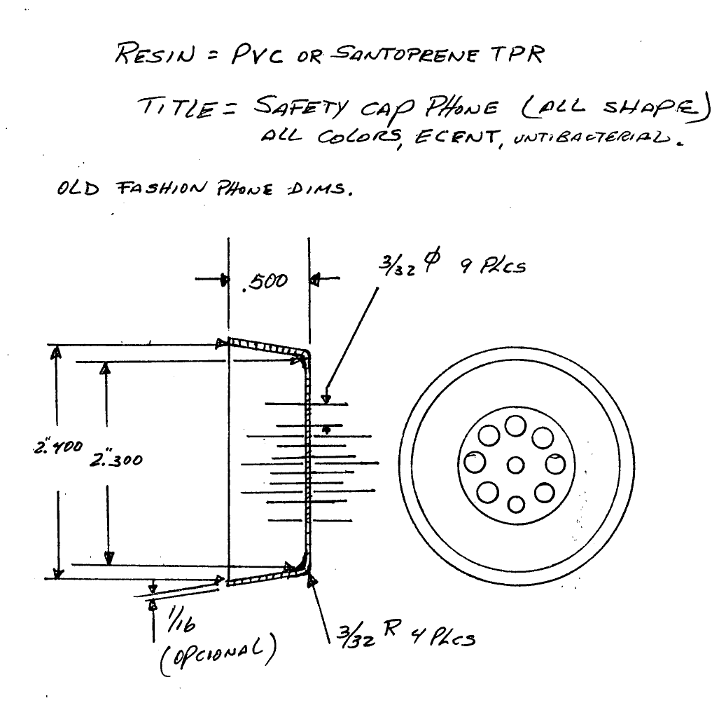

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of health and more specifically to prevent disease using a Safety Cap Phone.

Some years ago I was in San Diego, Calif. and had an emergency and I made use of a public telephone. It smelled like nasty, but the worst came a week later when I got an ear infection.

### BRIEF SUMMARY OF THE INVENTION

The primary object of the invention is Prevent's Disease.

Another object of the invention is Eliminates bad odors.

Another object of the invention is Makes talking on the phone comfortable.

A further object of the invention is Variety of colors and essence.

Yet another object of the invention is All shapes.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Safety Cap Phone comprising: Antibacterial, and Essence. A cap that assembles to the speaker and the auricular of any phone and helps prevent the spread of disease and infections and also helps to avoid foul odors.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turning now to the drawings . . . you will find an individual cap that assembles to the speaker and the auricular of any phone and helps prevent the spread of disease & infections and also helps to avoid foul odors.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Following FIGURE is a perspective view of the invention.

What is claimed is:

1. Safety Cap Phone comprising:
Antibacterial; and
Essence. A cap that assembles to the speaker and the auricular of any phone and helps prevent the spread of disease and infections and also helps to avoid foul odors.
